(19) United States
(12) Patent Application Publication
(10) Pub. No.: US 2006/0215649 A1
(43) Pub. Date: Sep. 28, 2006

(54) Network address converting apparatus using SSW tree

(76) Inventors: Chris Morrall, Richmond Hill (CA); Timothy Sweet, Toronto (CA); Duncan Weatherston, Toronto (CA); Maciej Siarkiewicz, Etobicoke (CA)

Correspondence Address: Chris Morrall, 55 Drynoch Avenue, Richmond Hill, ON, L4E 3E7, CA

(21) Appl. No.: 11/074,218

(22) Filed: Mar. 8, 2005

(51) Int. Cl. H04L 12/56

(52) U.S. Cl. 370/389; 709/245

(57) ABSTRACT

A network device specifically dedicated to the translation of IPv4 and IPv6 addresses using the SSW Tree. This device implements Application Layer Gateways for DNS, IP Telephony and other Internet Standard Protocols. It provides IPv4 to IPv4 translation as well as IPv4 to IPv6 translation and IPv6 to IPv4 translation. It uses a high performance look up algorithm to support extremely large rule sets of up to and beyond 100,000 rules. A management application which allows for the simplified management of complex rule sets. A system for the implicit creation of application distribution across networks that are comprised of similar address spaces.

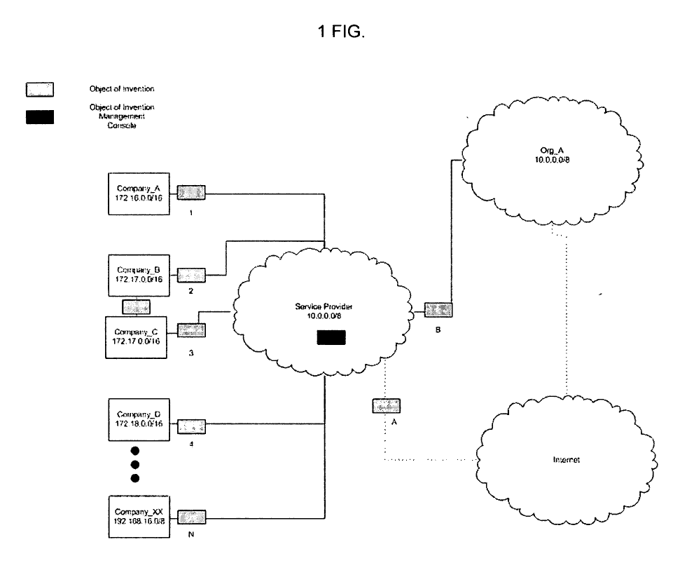

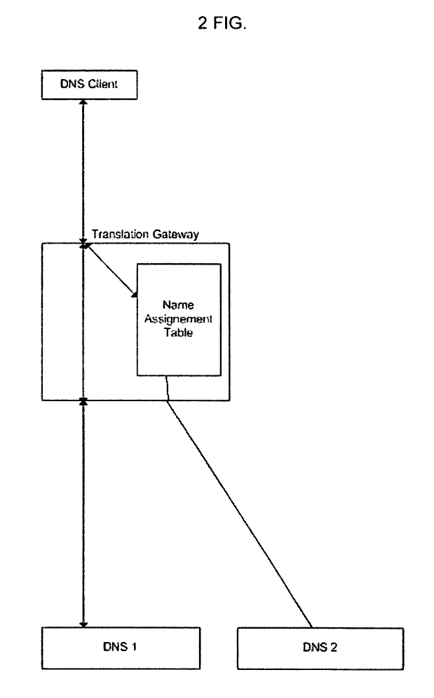

### BACKGROUND OF THE INVENTION

1. Field of the Invention

The present invention relates to the field of computer networks. More specifically it relates to Network Address Translation in complex environments.

2. Description of the Related Art

Network Address Translation, (NAT), was invented as a means to allow a single device to act as an agent between a public and private network. This means a single unique IP address can represent a group of computers. NAT was originally developed as a means to connect small networks to the Internet over a single dial up line and grew into an interim solution to combat IPv4 address depletion by allowing globally registered IP addresses to be re-used or shared by several hosts. NAT is used as a mechanism for conserving registered IP addresses in large networks and simplifying IP addressing management tasks. As its name implies, NAT translates IP addresses within private networks to ‘public’ IP addresses for transport over public networks such as the Internet. NAT allows an organization with unregistered “private” addresses to connect to the Internet by translating those addresses into globally registered IP addresses. NAT also increases network privacy by hiding internal IP addresses from external networks.

Where data is transmitted from the client to the external host, the router having the NAT capability converts the local IP address of the client to the Internet IP address assigned to that client. On the other hand, when data addressed to the client is received from the external host, the router converts the IP address designating the destination (that is the Internet IP address assigned to the client) to the local address of the client. Thus, communication between the client within the LAN and the external host is achieved.

NAT is typically implemented on firewalls, routers, layer3 switches and other multi-purpose network equipment. If large complex mappings are required, they consume resources on these systems and reduce their effectiveness at their primary task.

NAT is one mechanism to deal with the migration to IPV6 from IPV4 and since the address space for IPv6 is so large, the number of resources consumed will increase and the impact on other systems will also increase.

In general traffic is translated according to rules which describe the circumstances under which NAT should take place. This is usually in the form of attribute comparisons between the rule and the source and destination addresses and ports of the packet. The process by which these rules are looked up can be very resource intensive. In the case of large rule-sets this becomes prohibitive. Specifically in cases where there are more than 5,000 rules being compared against linear lookup mechanisms fail.

In order to manage NAT rules current implementations use explicit node definitions which are stored in lists and then associated with translation rules. While this mechanism is functional for small lists it breaks down when the number of objects grows large.

In many cases it should be possible to state that any traffic which is destined for systems on networks not explicitly known to be local is foreign. In this case it should be possible to automatically NAT without requiring additional configuration.

In pursuit of providing NAT support for very large and complex NAT rule sets it is necessary to over come the initial problem of identifying the appropriate rule to apply to traffic, prior to forwarding the packets. In current implementations of NAT, this step is accomplished by a line by line linear parse of the NAT rule set. This is a significant bottleneck as it limits the rate at which new sessions can be established.

NAT itself is broadly implemented and the invention will use existing high performance NAT mechanisms to carry through with NAT once a decision to perform translation and the addresses to assign has been performed.

### BRIEF SUMMARY OF THE INVENTION

Pursuant to the discussion above, this invention is a class of network equipment and user facing computer software, expressly designed for the application and management of complex network address translation rule sets for IPv4 and IPv6.

The object of this invention is to improve the efficiency of address translation by using a high efficiency tree in the initial lookup phase of the NAT operation. This process makes a binary tree search for the first matching rule of an initiating request adding the new session to a traffic flow state table and then forwarding the packet on to its destination through the rest of the NAT implementation.

In order to accomplish this, the NAT rule set is broken down into binary tokens and then inserted into a SSW tree. Inbound packets compared against the existing session state table. If they are not part of an existing flow the packet is forwarded to the lookup mechanism where it is tokenized appropriately and then compared to the tokenized rules to determine the best fit.

In order to simplify NAT in complex environments it is reasonable to try to automate as much of the process as possible. To that end, another object of this invention is the implementation of automatic NAT in combination with a Domain Name Service application layer gateway.

By implementing an application layer gateway for DNS it is possible to determine whether the response to an address request would conflict with address space known to the Translating gateway. If the address space is in conflict then the content would be replaced with an address associated with an interface on the gateway and a NAT rule would be added to manage traffic to and from the newly assigned gateway address.

It is an object of this invention that it uses the interface on which a packet arrives to determine which path to forward it. This mechanism is designed to allow for networks with similar address spaces to communicate. It is intended to be used in conjunction with the DNS ALG

It is another object of this invention to provide a user interface specifically designed for the implementation of large NAT rule sets. To that end the user interface embodies the concepts of applications and client networks. It is intended that applications are designated to exist with specific addresses and ports on known devices, these applications are then made available to the client community and then when the rules are distributed each machine is responsible for generating appropriate translation rules.

It is another object of this device that it be capable of managing 10,000 and up to an beyond 100,000 distinct rules.

### BRIEF DESCRIPTION OF THE SEVERAL VIEWS OF THE DRAWINGS

[1 FIG.] Drawing 1 represents an implementation of service provider network attached to the Internet, another service provider and several companies.

[2 FIG.] Drawing 2 represents an implementation of DNS replacement for transiting packets. When a request is received it is compared against a tree containing names that need to be translated if one is found the translation action is followed else the name lookup continues normally.

### DETAILED DESCRIPTION OF THE INVENTION

An example of a complex NAT configuration is depicted in Diagram 1. In this case the service provider network is the default path to the Internet for Company_A 1 and Company_B 2. It is the path to another organization Org_A 5 Company_C 3 and Company_D 4. Companies A and D share internal address space and Org_A the service provider network also use the entire 10.0.0.0 address space. In order to the service provider and Org_A to share communications through a single translation device, it must provide NAT based on the receiving interface. This is required if any of the companies whish to communicate with machines in Org_A.

In the following description, many specific details, are provided in order to give a more thorough description of the object of invention. It will be obvious for those skilled in the art that there are other mechanisms to achieve similar results for small rule sets. Some well-known features are not described in detail so as not to make the present invention unclear.

The first embodiment the object of invention is letter A on Diagram 1. This device is responsible for translating all communications from the internet for devices buried on the Service Provider network. Assuming that not all devices (1-N) have or need public addresses, it may be required to present all public address on Device A. This could, in the case of a large network, run to tens of thousands of NAT rules on this device.

In the second embodiment of the object, many devices are located on the service provider network. These are numbered 1-N. Each of these hides a well known address space. Typically a few class-C Internet addresses or perhaps a class B address. In this case the object of the invention presents a simplified mechanism for managing NAT in conjunction with DNS gateway. By installing the device in line with the wide area network access route it is possible for this device to NAT transparently and only when necessary

In the second embodiment the Management console in the service provider could be configured to push a single rule set that is implemented individually by the perimeter devices 1-N.

Another object of the invention is to provide a mechanism for the interception of DNS requests wherein an address in the local address space is returned to the requesting client so that translation can be performed for that destination. This occurs through one of two mechanisms. In the first case there is a Patricia tree which contains the stored names which might be requested. When a DNS request is received the requested name is looked up in the Patricia tree. If it is received the address stored there is returned. If the address is a local one for the purpose of translation it is either one which has been pre-assigned or it is created dynamically from a pool of available addresses. If it is created dynamically then the tree containing address translations is updated ‘on the fly’ with the new translation information.

The dynamically created NAT can be made to have any properties that a statically assigned NAT might. That is to say that it can include any of source address, destination address, source port, destination port and interface. This means that in various cases the assigned address could come from a pool assigned from the address space on the attached network or it could come from a ‘virtual pool’ that is routed to the translation device or it could come from a second DNS lookup against a different name entirely.

The translation device employs the concept of defined applications. These applications are defined as sets of addresses and ports. When a rule set is pushed to an individual translation node, the node may create DNS entries for the various components of the application so that the local configuration of the node will produce a local version of the associated translation rules. In this way a single definition of a NAT rule can be implemented on many nodes independently without requiring extensive local configuration.

An advantage of this approach to DNS is that it does not require translating devices to maintain complete copies of the DNS entries for a particular domain, since lookups which for nodes which are not defined result in the Name service request being processed in the normal way.

Part of the translation mechanism involves the automatic assignment of addresses and the application of interface base rules. This is necessary because the NAT device will potentially receive packets from networks that have the same address space as networks behind the translation device. In order to accomplish this, when a packet arrives on an interface it is compared against the known routes on the other interfaces. If it is in a known space a dynamic NAT is created based on the interface and the packet is forwarded through the appropriate interface.

Dynamically created NAT addresses can be managed by several mechanisms. They can be created permanently. This would be used in the case that address space is not a limitation and the device is being used to automatically learn the NAT requirements of a network. This would be the case for Company_A in diagram 1.

Dynamically created addresses can be give lifetimes which will expire after a specific amount of time has passed or which will expire after a certain amount of time has elapsed since the last use of the translation rule. This might be the case between Campany_B and Company_C in diagram 1.

Rules are defined on a central management console. This part of the invention is key to allowing for the management of large rule sets. A significant problem with current implementations of rule-based translation devices such as firewalls and routers is the mechanism wherein the rules are defined.

Rules are defined for the entire network on the management console so that there is little need to explicitly configure the information on each device. When the rules are distributed to each device, the local information is extracted and applied based on information pertinent to local addresses.

Communication between the devices and the management console is secured through AES encryption and authenticated with key based systems.

In order to implement translation between IPv4 and IPv6 it is necessary to translate various standard protocols on top of translating addresses. The most important of these is DNS and ICMP. This invention will use the fast lookup mechanism previously described to instantiate sessions and then implement a flows based mechanism for the ongoing NAT once the session is created.

An application is a hierarchical object that can be comprised of descriptions of source ports, source IP addresses, destination ports, destination addresses and applications. This mechanism allows for generality in the association of application functionality.

When creating new applications one may include references to previously defined applications without having to redefine them for each application.

In order to simplify management of great numbers of rules it is necessary to be able to sort and search for any attribute of any element defined within the rule set. This allows for the collation of similar objects which are then presented as a collection for further searching or other use

In an environment containing multiple translation devices, only those rules that are applicable to a given translating gateway are distributed to it. This reduces network traffic and the amount of work any particular device is required to do on a large network.

When rules are pushed to a translation device, the device returns the status of the transaction so that the management console is aware of the success or failure of the transaction.

Due to the diversity of network systems it is important that the control system be able to synchronize its information with as many gateway devices as possible. The control system is capable of supporting plug-ins to work with devices other than the translation apparatus described herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein.

In view of the wide variety of embodiments to which the principles of the present invention can be applied, it should be understood that the illustrated embodiments are exemplary only and should not be taken as limiting the scope of the present invention. For example, the steps of the flow diagrams may be taken in sequences other than those described, and more or fewer elements may be used in the block diagrams.

The claims should not be read as limited to the described order or elements unless stated to that effect. In addition, use of the term “means” in any claim is intended to invoke 35 U.S.C. sctn. 112, paragraph 6, and any claim without the word “means” is not so intended. Therefore, all embodiments that come within the scope and spirit of the following claims and equivalents thereto are claimed as the invention.

What we claim as our invention is:

1. An apparatus for the address translation of network packets designed to offload work from other network equipment:
Which is capable of supporting up to and beyond 100,000 translation rules
Which uses tree based lookup mechanisms to encode the rule base
Which automatically dynamically generates translation rules

2. The method of claim 1 for looking up rules comprising:
Using the SSW tree for fast rule lookups for converting addresses from a plurality of hosts to a plurality of destinations

3. The method of claim 1 where rules refer to descriptors of IPv4 or IPv6 network traffic.

4. The method of claim 3 where a rule is a description of a combination or plurality of:
a network source address and mask
a network destination address and mask
a source port and mask
destination port and mask
an interface
a logical group

5. The method of claim 1 used for dynamically deciding whether to perform the NAT operation based on knowledge of the network topology contained within the device.

6. The method of claim 5 for extracting information about network topology from the interface that a packet was received from.

7. The method of claim 5 to derive information from routing tables and other local information to determine dynamically the need for address translation.

8. The method of claim 1 that assigns reachable addresses for conflicting remote addresses by re-interpreting name service requests and inserting the altered address information in the request response packets.

9. The method of claim 8 in which DNS responses are modified to present the reachable addresses to the request client.

10. The method for the simplified distribution of applications to multiple offices:
Where the assigned address is derived from an available pool address space
Where the assigned address has a lifetime based on protocol requirements of the application

11. The method of claim 1 which uses classifications by application for the distinction of rule groups in support of up to and beyond 100,000 translation rules.

12. The method of claim 1 which uses a central management console to provision rules to multiple devices in support of up to and beyond 100,000 translation rules per device.

13. The method of claim 11 where an application is represented as a set of associated IP network addresses and ports.

14. The method of claim 12 where the communications between the management device and the various network devices are encrypted and authenticated.

15. The method of claim 3 where the originating network uses IPv6 and the destination network is using IPv4.

16. The method of claim 3 where the originating network uses IPv4 and the destination network uses IPv6.

17. The method of claim 9 where a list of names and addresses is stored and if such a name is requested the stored address is returned instead of making the full DNS request from the DNS server hosting the SOA.

18. The method of claim 13 where applications are hierarchical groups which may be composed of other applications.

19. The method of claim 18 where applications are included in multiple application hierarchies as a virtual representation of the referenced applications.

20. A method of claim 11 to determine where a particular network object is referenced within the set of rules and applications defined by the user interface.

21. A method of claim 11 where translation rules can be sorted and filtered based on any element of the rule definition in the set of rules managed by the user interface.

22. A method of claim 12 where only applicable translation rules are deployed to any given device.

23. A method of claim 14 where status information is securely exchanged between the translation devices and the management console.

24. A method of claim 14 where communications are adaptable to an arbitrary syntax through a plug-in architecture.
